(19) United States
(12) Patent Application Publication
(10) Pub. No.: US 2025/0378466 A1
(43) Pub. Date: Dec. 11, 2025

(54) COMPUTER-IMPLEMENTED CAMPAIGN VISUALIZATION TOOLKIT

(71) Applicant: Cramer & Associates, Inc., Dublin, OH (US)

(72) Inventors: Michelle CRAMER, Plain City, OH (US); Madelyn Andrews, Columbus, OH (US); Jonah Fortkamp, Columbus, OH (US); Dawn Robinson, Dublin, OH (US)

(73) Assignee: Cramer & Associates, Inc., Dublin, OH (US)

(21) Appl. No.: 18/735,848

(22) Filed: Jun. 6, 2024

(51) Int. Cl. G06Q 30/0242; G06Q 30/0279

(52) U.S. Cl. CPC G06Q 30/0243; G06Q 30/0279

(57) ABSTRACT

Systems and methods for campaign data visualization. A system includes a campaign tool kit manager implemented on a server. The campaign toolkit manager includes a page generator configured to generate one or more pages visualizing campaign data, a donor manager configured to manage donor information relating to a campaign, and a pyramid builder configured to generate pyramid configuration data representative of allocated donor slots for a campaign. A computer-implemented method for managing campaign data visualization includes setting a campaign goal for the campaign, generating pyramid configuration data representative of allocated donor slots for the campaign based on initial campaign data, and generating a gift pyramid display page based on the pyramid configuration data for output to the campaign interface tool. A user can view or edit gift pyramid information shown in the gift pyramid display page.

### CROSS-REFERENCE TO RELATED APPLICATIONS

None.

### TECHNICAL FIELD

The technical field relates generally to computer-implemented data visualization and campaign data management.

### BACKGROUND

Computer-implemented technologies have been used to document, track, and measure fundraising progress. General purpose software applications, such as, spreadsheet applications and database management tools have been used to track donor records and contributions. However, such messaging and tracking does not provide any capability or insight on how to manage a fundraising campaign. Extensive manual maintenance and update spreadsheets or other records is required. None of the general purpose applications provide user-interface management or display views that provide immediate insight or control into campaign fundraising progress or management of a fundraising campaign.

### BRIEF SUMMARY

The inventors recognized that what is needed are computer-implemented systems and methods for visualizing and managing campaign data. Computer-implemented systems and methods are needed to optimize allocations of donation levels to meet campaign fundraising goals.

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one aspect, a system for campaign data visualization includes a campaign tool kit manager implemented on a server configured to communicate over a data network with a remote computing device. The system includes a database coupled to the server and configured to store campaign data. The campaign toolkit manager includes a page generator configured to generate one or more pages visualizing campaign data, a donor manager configured to manage donor information relating to a campaign, and a pyramid builder configured to generate pyramid configuration data representative of allocated donor slots for a campaign.

In another aspect, a computer-implemented method for managing campaign data visualization includes storing initial campaign data in a database and generating, with a campaign toolkit implemented on a server, a home page having information identifying one or more campaigns and one or more user-interface elements enabling a user to select a respective campaign. The method includes generating with the campaign toolkit a navigation page for a selected campaign, the navigation page having one or more campaign management buttons, generating with the campaign toolkit one or more campaign management pages corresponding to selection by a user of one or more campaign management buttons, and enabling a user to view or update campaign data in respective campaign management pages. Finally, the method includes storing updated campaign data in the database for access by the campaign toolkit and propagating the updated campaign data in one or more campaign management pages for a selected campaign.

In a further aspect, a computer-implemented method for managing campaign data visualization for a fundraising campaign is provided. The method includes initializing campaign data with a campaign toolkit, implemented on a server and configured to communicate with a campaign interface tool on a remote device, including setting a campaign goal for the campaign, generating pyramid configuration data representative of allocated donor slots for the campaign based on the initialize campaign data, and generating a gift pyramid display page based on the pyramid configuration data for output to the campaign interface tool, whereby, a user can view or edit gift pyramid information shown in the gift pyramid display page.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number generally refer to the figure number in which that element is first introduced.

FIG. 1 is a diagram of a computer-implemented campaign toolkit system in accordance with one embodiment.

FIG. 2 is a flowchart diagram of a computer-implemented method for initializing a campaign in accordance with an embodiment.

FIGS. 3A and 3B are flowchart diagrams of a computer-implemented method for managing a campaign with the system of FIG. 1 in accordance with an embodiment.

FIG. 4A is a diagram of routine further showing the operation of a campaign toolkit system in accordance with another embodiment.

FIG. 4B is a diagram of a campaign toolkit system hosted on a network in accordance with another embodiment.

FIG. 4C is a diagram illustrating a table of campaign data in accordance with an embodiment.

FIGS. 5-10 are diagrams that illustrate display views having example pages output on a device to a user in accordance with an embodiment.

FIG. 11 is a flowchart diagram of a computer-implemented method for managing donor information with a campaign toolkit system in accordance with an embodiment.

FIG. 12 is a flowchart diagram of a computer-implemented method for managing a fundraising campaign with a campaign toolkit system in accordance with an embodiment.

FIG. 13 is a flowchart diagram of a computer-implemented method for generating a new gift pyramid display view in accordance with an embodiment.

FIGS. 14-25 are diagrams that illustrate display views having example pages output on a device to a user during management of a non-profit fundraising campaign in accordance with an embodiment.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

In embodiments, computer-implemented systems and methods for visualizing and managing campaign data are provided. Computer-implemented systems and seamless methods are provided which help optimize allocations of levels and donor slots to meet campaign fundraising goals.

### 1. System

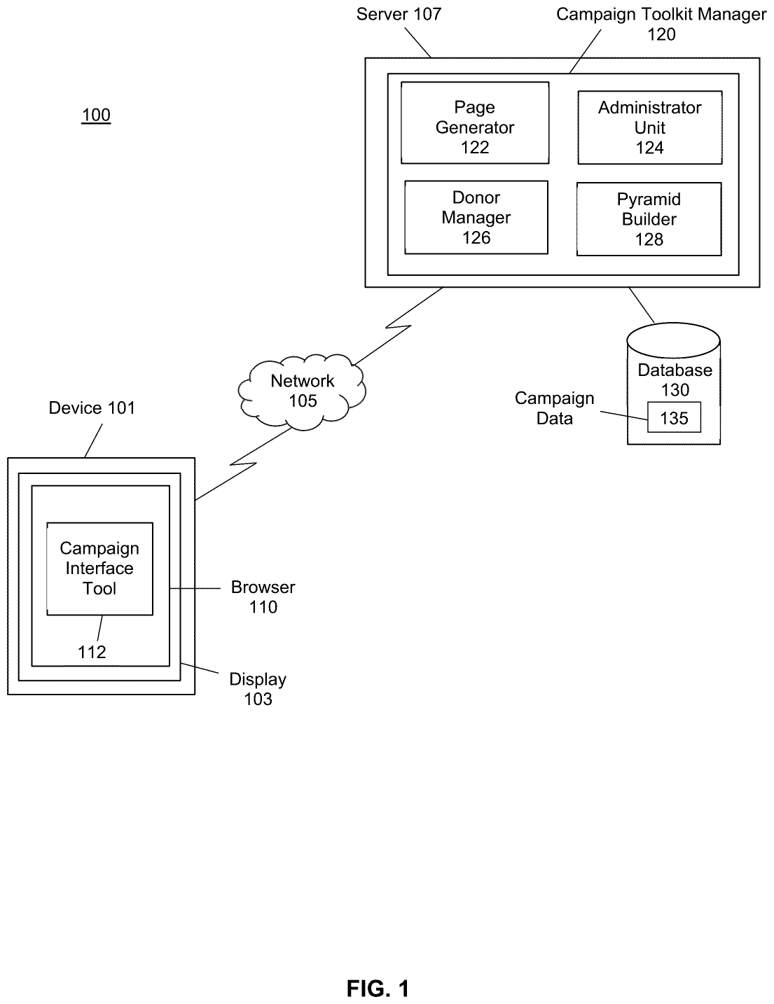

FIG. 1 is a diagram of a computer-implemented campaign toolkit system 100 for campaign data visualization in accordance with one embodiment. System 100 includes one or more devices 101 coupled over a data network 105 to a server 107. Device 101 is a computing device having a display 103. In one example, device 101 includes a browser 110. Server 107 is also a computing device which can communicate over data network 105 with one or more devices 101. Server 107 is further coupled to a database 130.

In one embodiment, system 100 includes a campaign interface tool 112, campaign toolkit manager 120, and campaign data 135. Campaign toolkit manager 120 includes page generator 122, administrator unit 124, donor manager 126 and pyramid builder 128. Database 130 stores campaign data 135. Page generator 122 is configured to generate one or more pages visualizing campaign data and/or facilitating management of a campaign. Administrator unit 124 is configured to handle registration, authentication and log-in of users. Donor manager 126 is configured to manage donor information relating to a campaign. Pyramid builder 128 is configured to generate pyramid configuration data representative of allocated donor slots for a campaign. A controller may be included to control operation between each of page generator 122, administrator unit 124, donor manager 126 and pyramid builder 128.

As shown in FIG. 1, campaign interface tool 112 may be downloaded or installed on device 101. Campaign interface tool 112 may be an application, such as, an application running under control of an operating system on device 101 or a web application operating through browser 110. Campaign toolkit manager 120 may be an application implemented on server 107. Server 107 may also include or be coupled to a web server (not shown).

Campaign interface tool 112 may be implemented in software, firmware, hardware or any combination thereof. Also campaign toolkit manager 120 and each of its components (page generator 122, administrator unit 124, donor manager 126 and pyramid builder 128) may be implemented in software, firmware, hardware or any combination thereof on the same or different processors.

In embodiments, device 101 can be any electronic computing device. A user can enter control inputs through a user interface (such as a keyboard, microphone, or touchscreen). For example, device 101 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (wired or wireless) over network 105.

Network 105 may be any type of data networks or combination of data networks, including but not limited to, a local area network, medium area network or wide area network, such as, the Internet. Server 107 may be implemented as a single server or part of a group of servers. One or more servers 107 may include one or more processors and computer-readable memory and can be distributed at the same or different locations. Web servers may also be included and coupled to servers 107 or part of servers 107 to support operations and enable communications (through Web protocols and networking layers) between the platform and browsers 110 on remote computing devices 101. Application programming interfaces (APIs) may also be used to call different services and functions to distribute aspects of the functions of campaign toolkit manager 120 and each of its components (page generator 122, administrator unit 124, donor manager 126 and pyramid builder 128) on different computing devices over network 105.

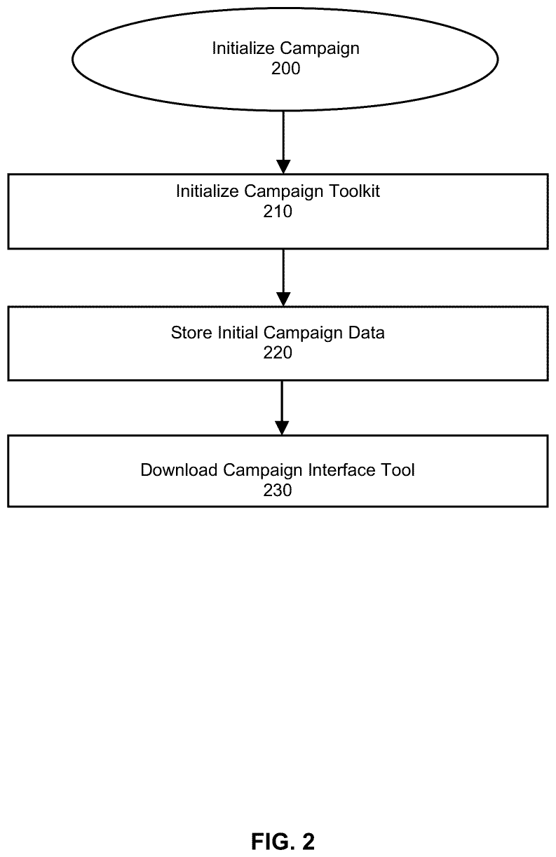

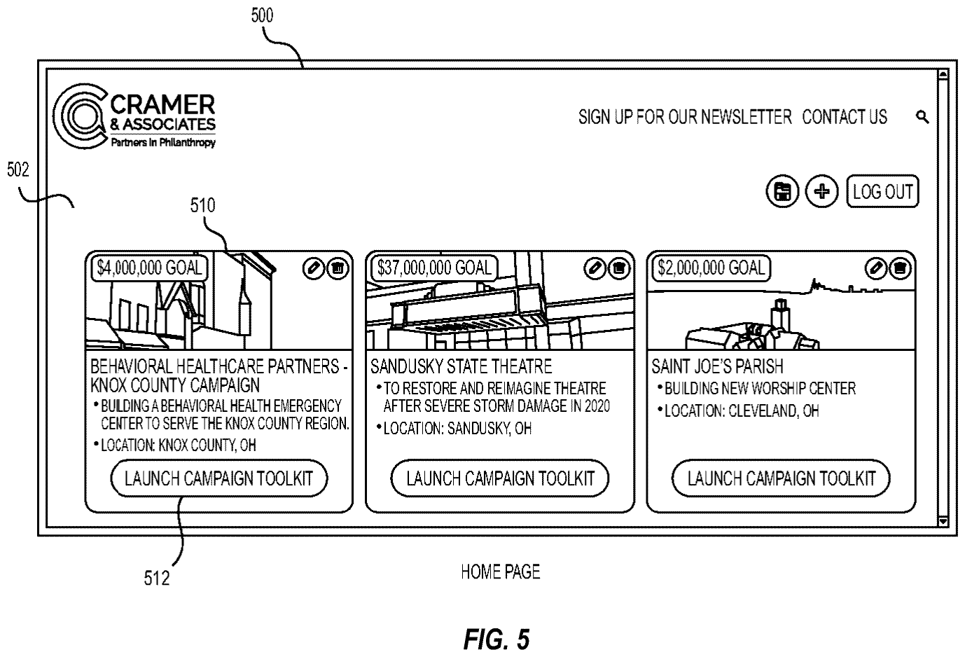

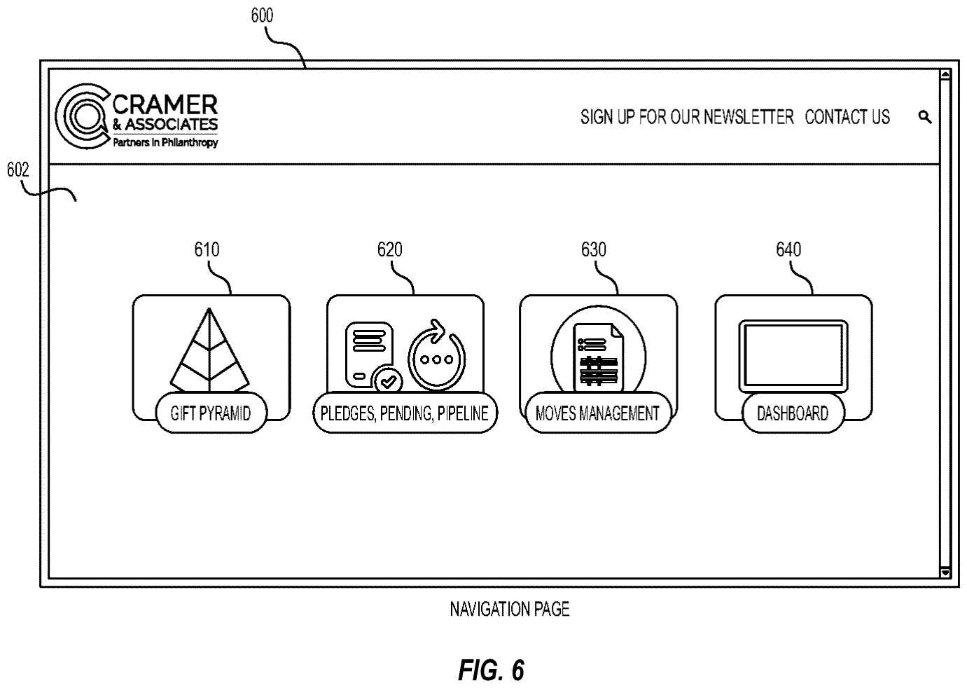

The operation of system 100 including campaign interface tool 112 and campaign toolkit manager 120 and each of its components (page generator 122, administrator unit 124, donor manager 126 and pyramid builder 128) is described further below with respect to routines and example data in FIGS. 2-4C and 11-13 and example user-interface operations and display pages shown in FIGS. 5-10 and 14-25.

### 2. Operation

a. Initializing a Campaign

FIG. 2 is a flowchart diagram of a computer-implemented method 200 for initializing a campaign in accordance with an embodiment (steps 210-230). In step 210, a campaign toolkit is initialized. For example, a campaign toolkit manager 120 may be accessed to initialize a campaign. This may involve an administrator creating a new campaign and assigning a campaign name. Administrator unit 124 for example may check a user's log-in credentials and verify a user is an approved administrator with rights to initiate and manage campaigns.

Initial campaign data 135 is stored in database 130 (step 220). For example, this initial campaign data may include a campaign name and associated campaign identifier (campaign ID). Administrator and authorized user information may also be collected by administrator unit 124 and stored in records in database 130 for the campaign. One or more donor records may also be stored or associated with the campaign.

In step 230, campaign interface tool 112 may be downloaded to the administrator or other authorized user for the campaign. As mentioned above, this campaign interface tool 112 can be downloaded as an application or accessed as a web application through a browser. In this way, a user accessing campaign interface tool 112 on device 101 may view and make inputs through a user-interface to one or more pages to control visualization of campaign data displayed to the user and to manage allocation of donor slots to achieve campaign goals.

b. Managing a Campaign

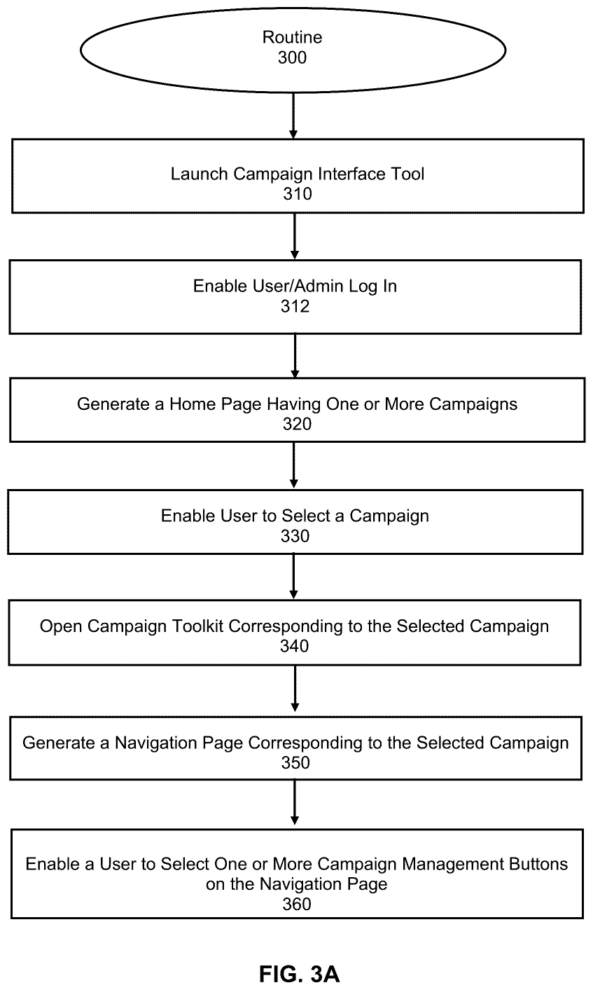

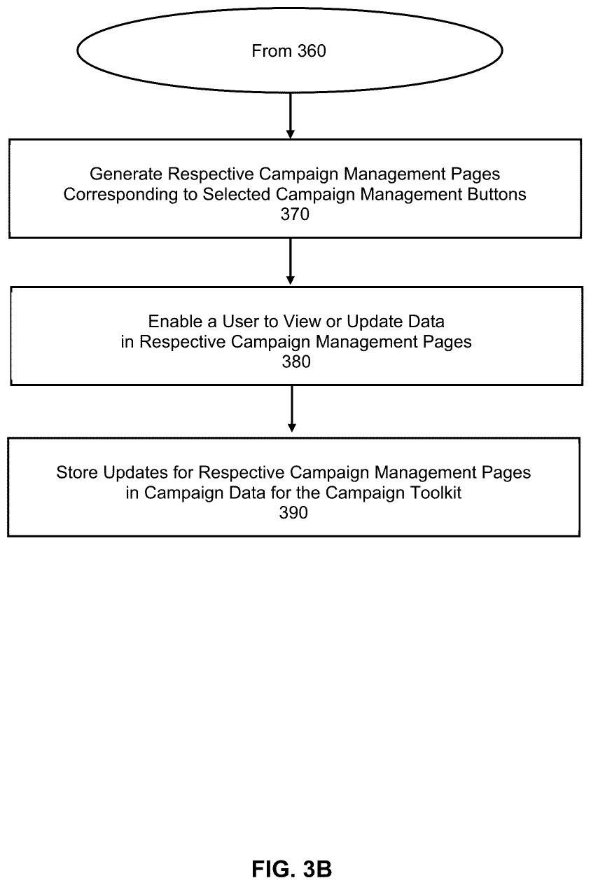

FIGS. 3A and 3B are flowchart diagrams of a computer-implemented method 300 for managing a campaign with the system of FIG. 1 in accordance with an embodiment (steps 310-390). In one embodiment, method 300 may be performed by campaign toolkit manager 120 and campaign interface tool 112 in communication with one another to send data and requests over network 105.

In step 310, campaign interface tool 112 is launched. For example, a user at device 101 may select to open or initiate campaign interface tool 112. Depending on a configuration, this may be done by directing browser 110 to a website address hosting campaign toolkit manager 120. Campaign toolkit manager 120 at server 107 may then send script or other instructions to browser 110 to perform the functions of a campaign interface tool 112 as a web application at device 101. For brevity, method 300 and the operation of campaign interface tool 112 is described with respect to a web application; however, this is not intended to be limiting and other implementations may be used, such as, campaign interface tool 112 operating as a standalone application on device 101.

In step 312, an administrator or other authorized user is enabled to log in. For example, administrator unit 124 may request log-in credentials (such as, a username and password, or biometric identifier, or multi-factor authentication), verify the credentials and enable an authorized user to proceed to operate campaign interface tool 112. Once a user is authorized, control proceeds to enable campaign toolkit manager 120 to provide one or more pages to device 101 for display.

In step 320, a home page having one or more campaigns is generated. As shown in FIG. 5, a home page 500 may be generated by page generator 122 and output to campaign interface tool 112 for display. For example, page generator 122 may access campaign data 135 associated with the authorized user and generate home page 500. Home page 500 includes a display panel 502 having campaign information 510 (such as a photo and text) and an associated campaign selection button 512 for each available campaign.

In step 330, a user is enabled to select a campaign. For example, a user may select campaign selection button 512 through a user interface and campaign interface tool 112 will send a notification of the selection to campaign toolkit manager 120.

Campaign toolkit manager 120 will then open a campaign toolkit corresponding to the selected campaign (step 340). For example, when a user selects an organization's fundraising campaign 510 as shown in FIG. 5, a campaign toolkit associated with the selected campaign will open. This may involve invoking an instance of a campaign toolkit and reading a campaign ID associated with the selected campaign to access relevant campaign data.

Control proceeds to direct page generator 122 to generate a navigation page corresponding to the selected campaign (step 350). For example, page generator 122 may generate a navigation page 600 having a display panel 602 with one or more campaign management buttons 610-640. In one feature, the campaign management buttons include a set of four buttons made up of a gift pyramid button 610, a pledges, pending, pipeline (PPP) button 620, a relationship action plan (RAP) button 630, and a dashboard button 640.

In step 360, a user is enabled to select one or more campaign management buttons 610-640 through a user interface and campaign interface tool 112 will send a notification of the selection to campaign toolkit manager 120. In response, to receipt of the selection of a campaign management button, campaign toolkit manager 120 may then access campaign data 135 and generate corresponding pages that relate to the selected campaign management button (step 370) as shown in FIG. 3B. The output campaign management pages in turn enable a user to view or update data in a respective campaign (step 380). A user may interact with the pages through a user-interface and campaign interface tool 112 will send a notification of user inputs and selections to campaign toolkit manager 120. Campaign toolkit manager 120 may then store updates to campaign data 135 in database 130 based on the received user inputs and selections made in response to the campaign management pages (step 390).

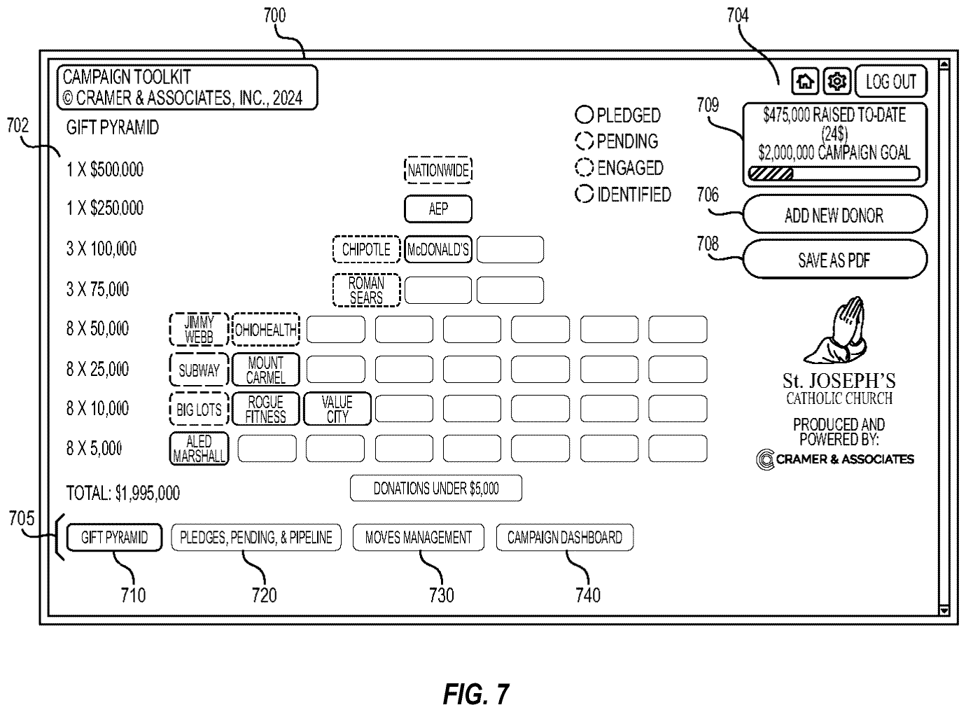

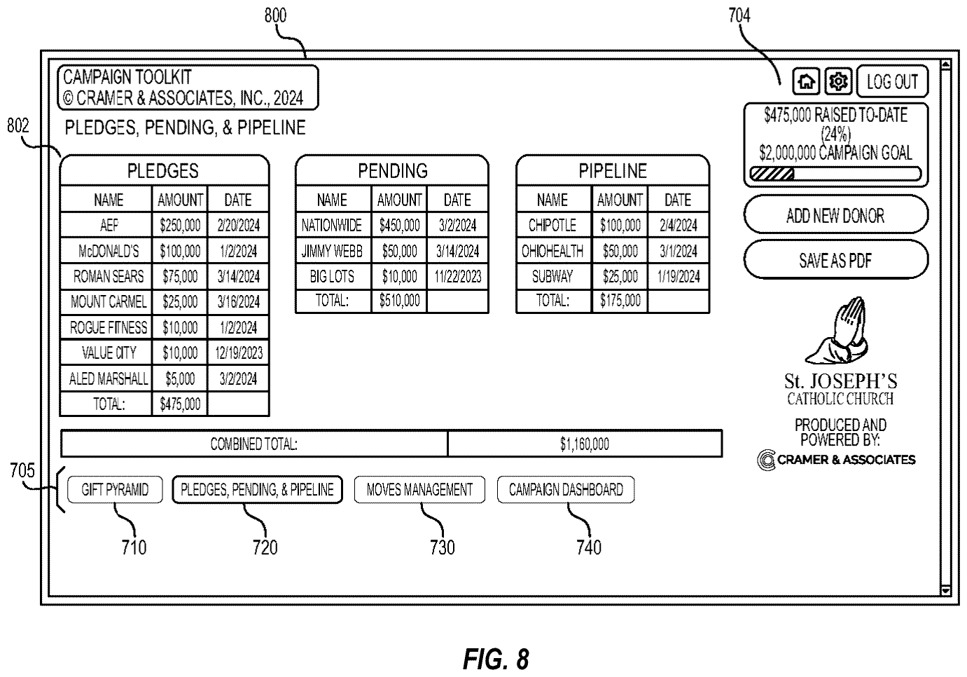

For example, page generator 122 may output a gift pyramid page 700 as shown in FIG. 7 for display in response to a user selection of the gift pyramid button 610. The displayed gift pyramid page 700 includes a display panel 702 displaying a graphical representation having an approximately pyramid shape made up of multiple levels each with one or more boxes corresponding to respective donor slots allocated for donors. A user through a user-interface at campaign interface tool 112 may select a box to flip or hover to view additional donor information.

In a further feature, the boxes in the graphical representation have a color or other indication denoting the status of a respective donor pledge. The status of the donation for example may be pledged, pending, engaged, or identified. Pledged may mean a donor has made a specific pledge of a donation amount and payment has been made or will be made in an agreed upon cadence or schedule. Pending may mean a donation request has been made but no payment or pledge has been received. Engaged may mean a donor has engaged with a campaign through messaging, meeting attendance, or other activity but no pledge or pending request has been made. Identified may mean a donor has been identified as of potential relevance to a campaign but no other engagement has occurred.

Page 700 may also include a display panel area 704 having user interface elements, such as, a button 706 to enable a user to add new donor information and a button 708 to enable the page with the graphical representation 702 to be saved as a file in PDF or another file format. A fundraising status indication 709 such a bar graph and text showing amount raised to date and percentage of goal reached may be shown. Page 700 may also have a menu bar 705 with a set of menu options 710-740. Menu bar 705 enables a user to select to display a gift pyramid page (menu option 710), a PPP page (menu option 720), a RAP page (menu option 730) or a campaign dashboard page (menu option 740).

As shown in FIG. 8, page generator 122 outputs a PPP page 800 when a user selects menu option 720. PPP page 800 includes a display panel 802 illustrating campaign data for pledges/donations received, pending donations, and a pipeline of prospective donors. PPP page 800 may also include a display panel 704 and menu bar 705 as described above for page 700 to further allow a user to view and manage campaign data.

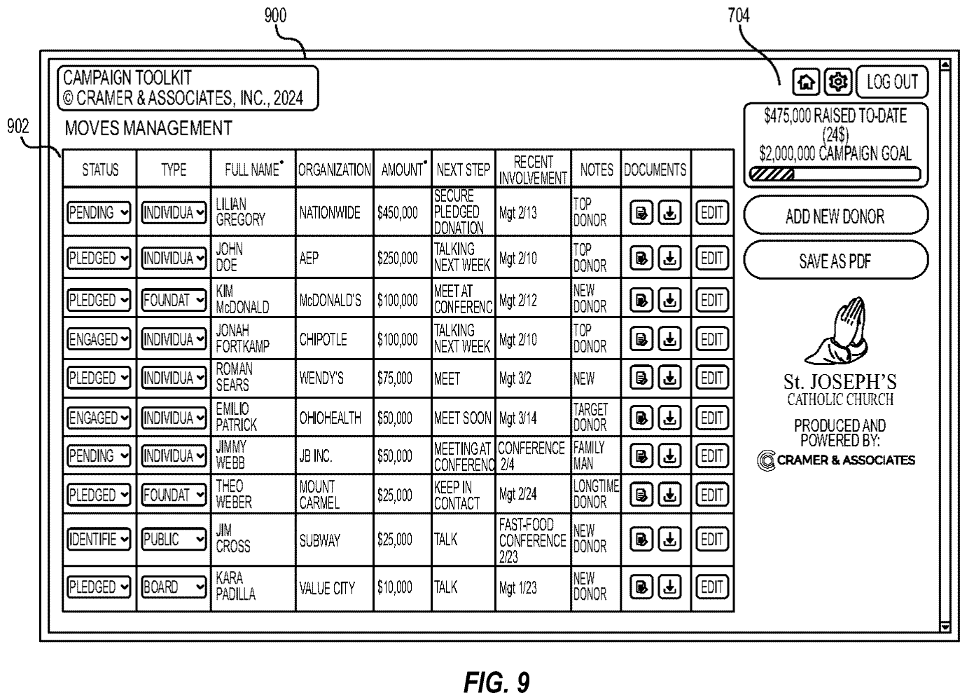

As shown in FIG. 9, page generator 122 outputs a RAP page 900 when a user selects menu option 730. RAP page 900 includes a display panel 902 illustrating campaign data relating to individual donors and their pledges and donations. For example, panel 902 may have a graphical representation showing donor pledge and activity information and can include user interface elements to enable a user to add or edit notes, add and download documents and edit donor information relating to a respective donor. RAP page 900 may also include a display panel 704 and menu bar 705 (not shown) as described above for page 700 to further allow a user to view and manage campaign data.

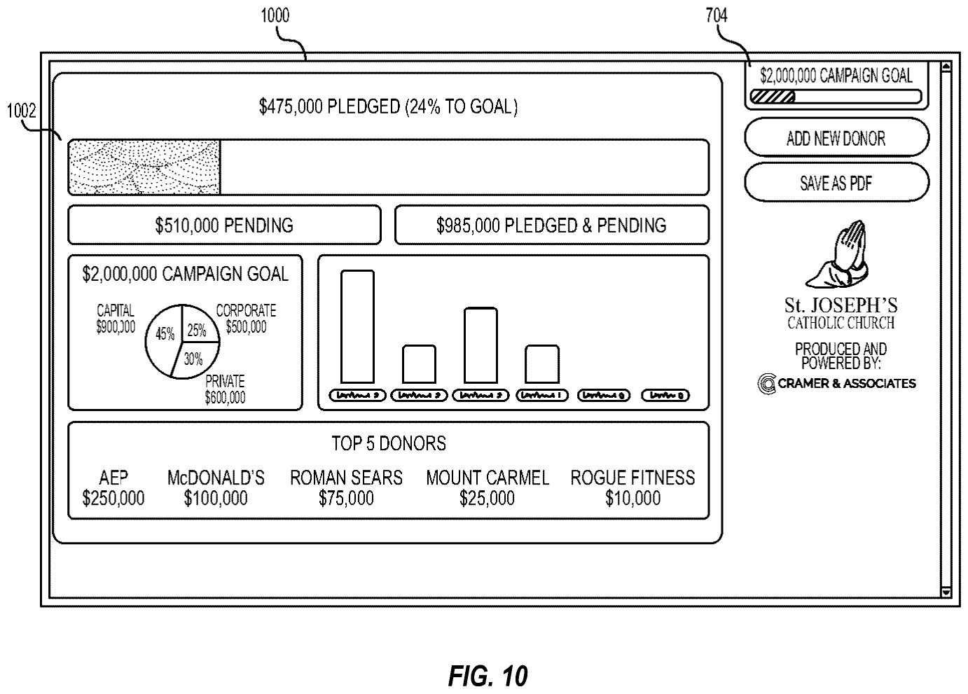

As shown in FIG. 10, page generator 122 outputs a campaign dashboard page 1000 when a user selects menu option 740. Dashboard page 1000 includes a display panel 1002 illustrating a graphical representation that shows summary information about one or more of total amount pledged, percentage of campaign goal met by donor pledges, and top donor information. Dashboard page 1000 may also include a display panel 704 and menu bar 705 (not shown) as described above for page 700 to further allow a user to view and manage campaign data.

c. Managing and Propagating Donor Information

In a further feature, campaign toolkit manager 120 allows donor information to be managed and propagated throughout campaign management pages shown to a user.

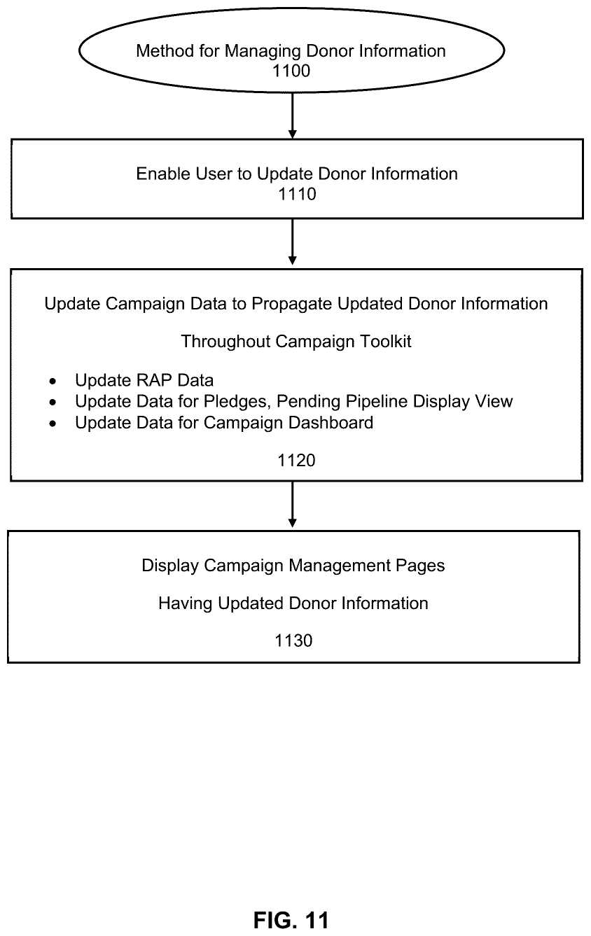

FIG. 11 is a flowchart diagram of a computer-implemented method for managing donor information 1100 with a campaign toolkit system 100 in accordance with an embodiment (steps 1110-1130).

In step 1110, a user is enabled to update donor information for a campaign. For example, page generator 122 may output one or more user-selectable campaign management pages 700-1000 which allow entry of updated donor information as described above. In step 1120, campaign data may be updated to propagate updated donor information throughout a campaign toolkit. For example, donor manager 126 may identify and receive updates to donor information (such as adding a new donor, updating status of donation such as a new pledge). Donor manager 126 may then update the campaign data 135 stored in database 130 to reflect the updated donor information.

For example, in one embodiment, stored campaign data 135 includes a relationship action plan (RAP) table, donor data records, and a campaign identifier (ID). In response to updates made by a user or administrator using campaign toolkit manager 120, donor manager 126 may identify the updates and store the updated donor information for a campaign to a corresponding RAP table or underlying donor records associated with a campaign ID.

Finally, in step 1130, campaign management pages are generated and displayed which have or reflect the updated donor information. Campaign toolkit manager 120 retrieves the updated data in campaign data 135 to allow updates in donor information to be viewed and managed in display pages for a campaign. For example, page generator 122 may generate one or more campaign management pages 700-1000 having the updated campaign data in real-time as updates are made to campaign data 135 stored in database 130. Because updated data is stored in a common RAP table, updates can be propagated more efficiently by campaign toolkit manager 120 with less data storage requirements and more quickly with less processing time than separate data storage requests and retrievals would require.

d. Managing a Fundraising Campaign

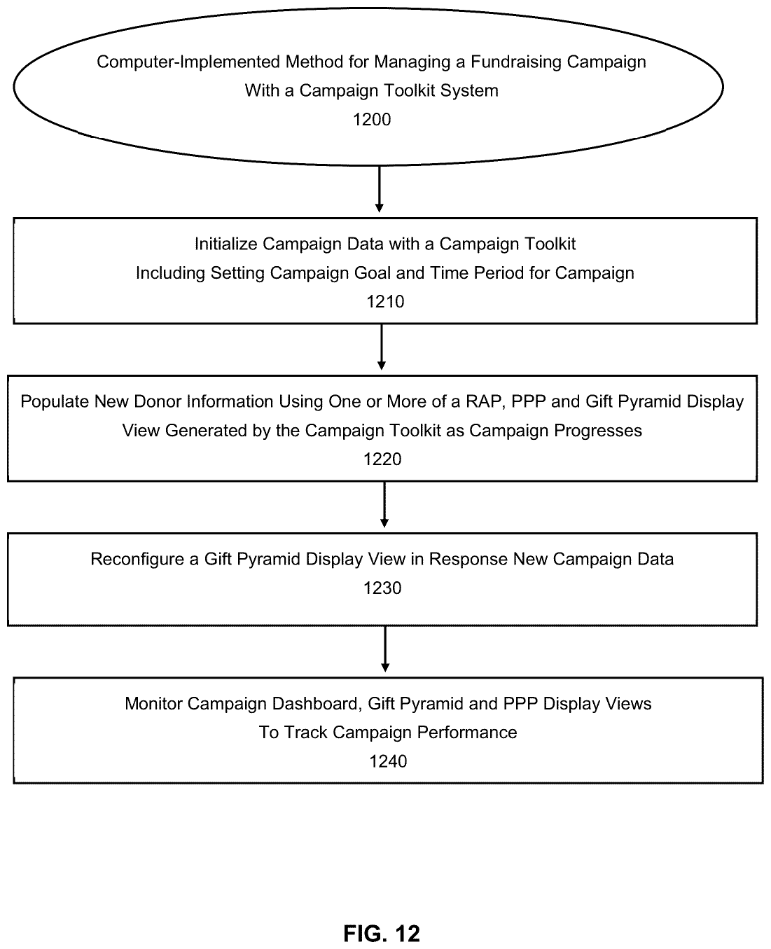

FIG. 12 is a flowchart diagram of a computer-implemented method for managing a fundraising campaign 1200 with a campaign toolkit system 100 in accordance with an embodiment (steps 1210-1240). In step 1210, campaign data 135 is initialized by campaign toolkit manager 120. This initialization may include setting a campaign goal and/or a time period for a campaign. For example, one or more pages may be provided which allow the user to input through a user-interface a campaign goal and/or a time period (duration) for a campaign. Default values for a campaign goal or a time period may also be used.

In step 1220, new donor information is populated using one or more of a RAP table, PPP and gift pyramid display page view generated by the campaign toolkit as a campaign progresses. New donor information is stored as updated campaign data 135 in database 130 and propagated in new campaign management pages generated by page generator 122 as the campaign progresses.

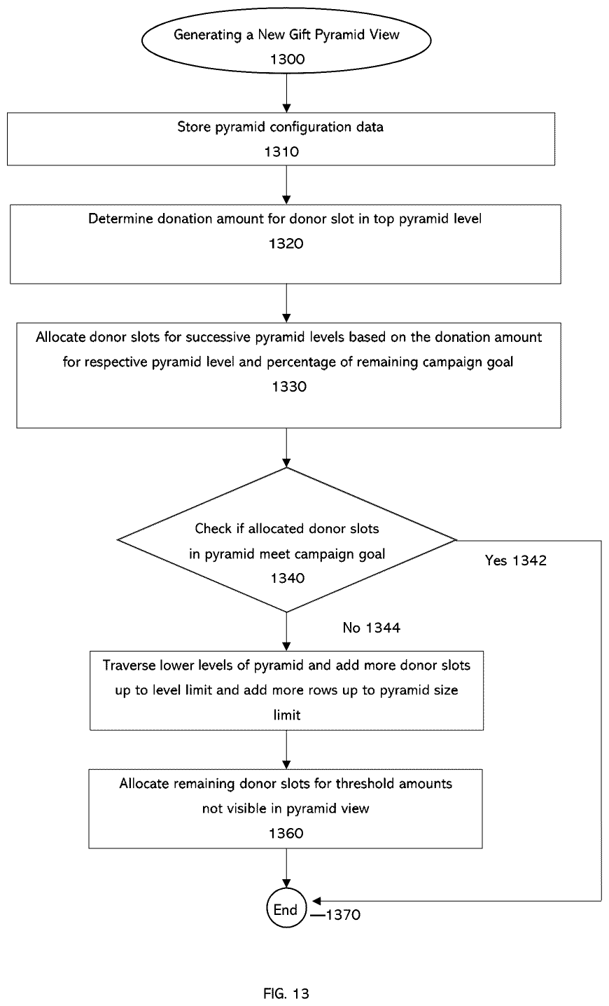

In step 1230, a gift pyramid display view is also reconfigured in response to new campaign data (such as new donor information or a new campaign goal) as a campaign progresses. Reconfiguration of the gift pyramid display view may also occur in response to a user selection or input made to the pyramid, such as, setting or changing a campaign goal, adding or editing donor information, manipulating the pyramid levels or donor slots, or inputting specific commands. A routine for generating a new gift pyramid view according to a feature is described in further detail below respect to FIG. 13.

Finally, campaign toolkit manager 120 outputs updated campaign management pages to a remote campaign interface tool 112 which allows a user to track campaign performance (step 1240). These updated campaign management pages may include display views having a campaign dashboard, gift pyramid, PPP or RAP information as described above.

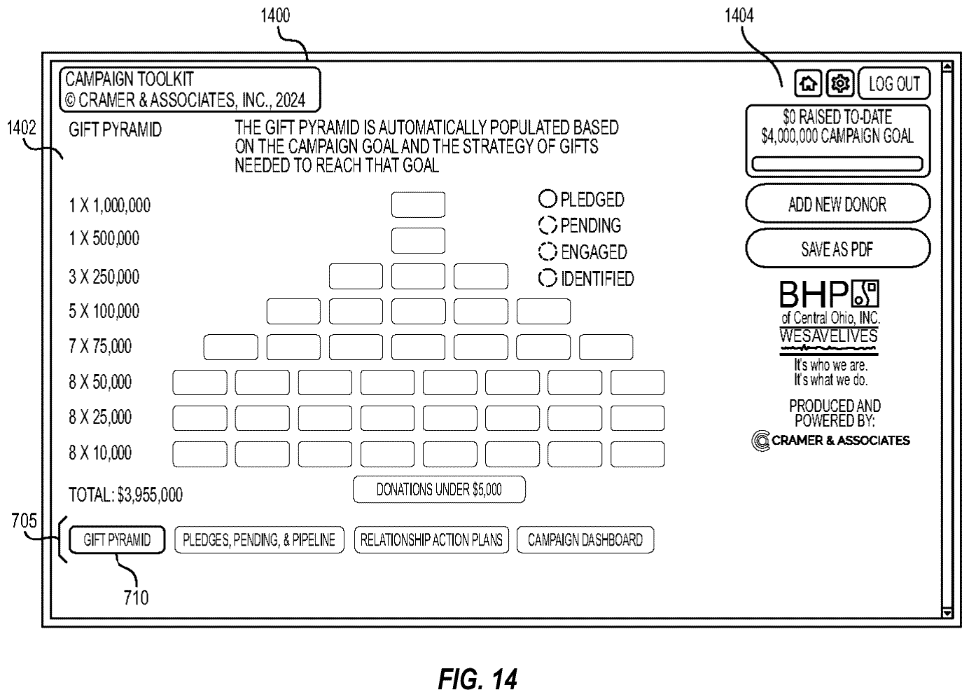

The updating of campaign data as a campaign progresses from start to finish for a fundraising time period is shown in FIGS. 14-25. FIGS. 14-25 illustrate display views having example pages output on a device to a user during management of a non-profit fundraising campaign at different stages of a campaign in accordance with an embodiment.

FIGS. 14-17 show campaign management pages that may appear at the beginning of a campaign. As shown in FIG. 14, a gift pyramid page 1400 may be displayed. Page 1400 has a display panel 1402 showing a graphical representation of a pyramid with multiple levels and boxes allocated for donor slots. However, the boxes are shown in blank form indicate no pledges have been received or prospective donors have been inputted as it is the start of the campaign. A scale alongside the pyramid shows a threshold amount and the number of boxes allocated for each respective level. In this case, a campaign goal is set to $4M and a top level has one box allocated at a $1M threshold or 25% of the goal. Successive levels have lower threshold amounts and one or more boxes allocated to form an approximate pyramid shape as shown. For clarity, only eight levels are shown and any donations below the last level threshold amounts are not shown. The gift pyramid can extend past eight levels, but automatically defaults to eight levels.

Page 1400 may also include a display panel 1404 having user interface elements, such as, a button to enable a user to add new donor information and a button to enable the page with the graphical representation to be saved as a file in PDF or another file format as described above with respect to panel area 704. A fundraising status indication such a bar graph and text showing amount raised to date and percentage of goal reached may be shown. Page 1400 may also have a menu bar 705 with a set of menu options 710-740 for a campaign as described above.

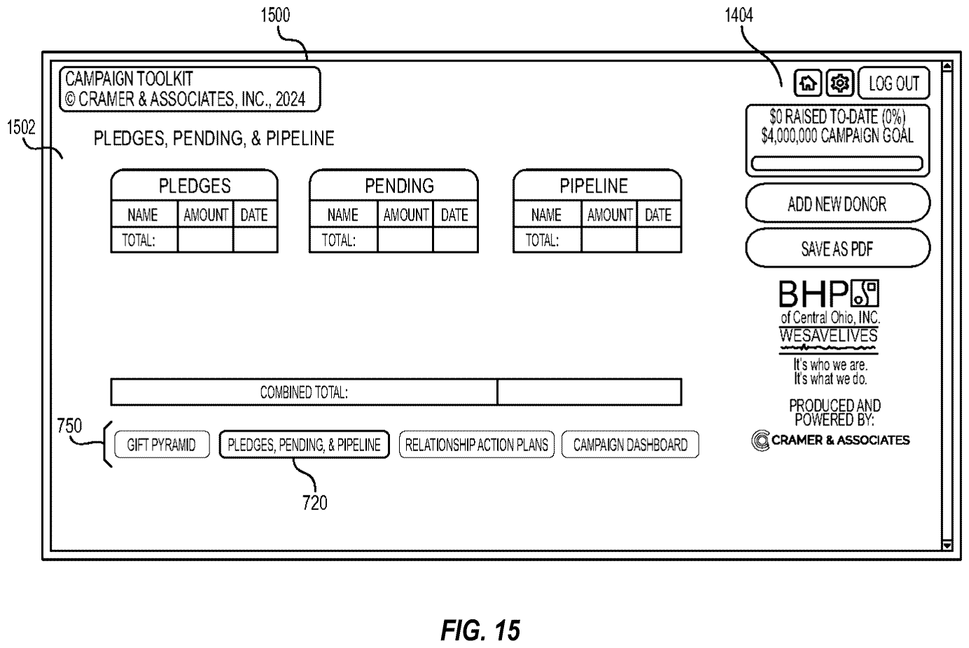

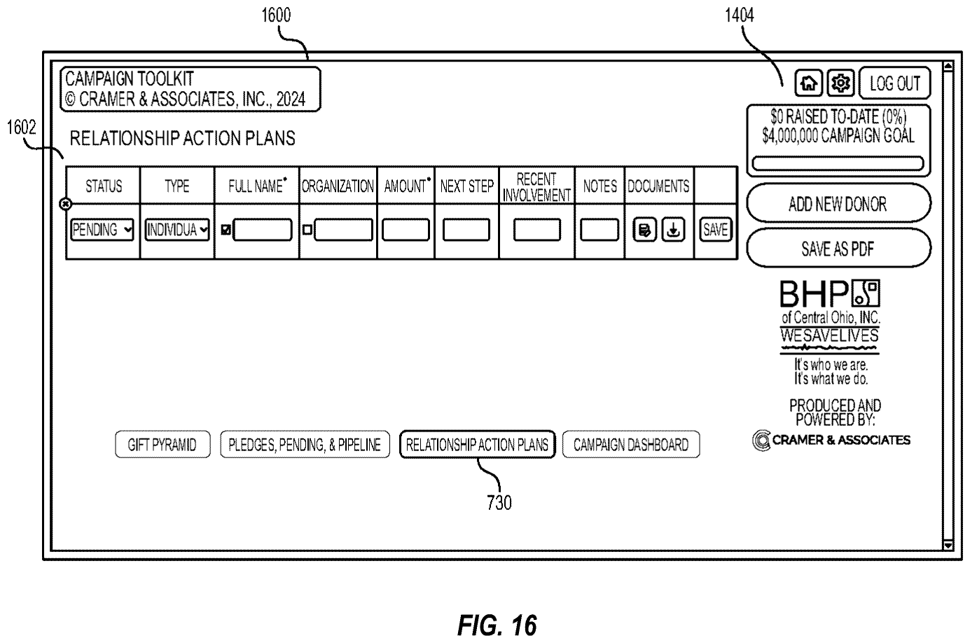

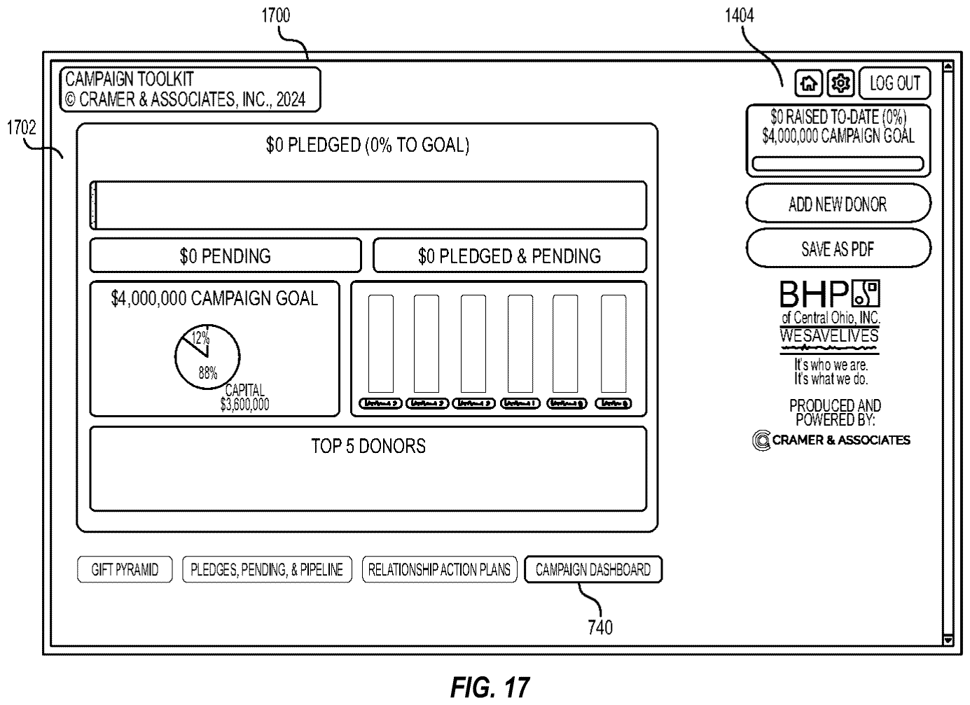

Similarly, at the beginning of a campaign, other display pages 1500, 1600 and 1700 may be generated as shown in FIGS. 15-17. Display page 1500 in FIG. 15 has a display panel 1502 illustrating campaign data for pledges/donations received, pending donations and a pipeline of prospective donors, however, tables are empty since no pledges or pending donations have yet been made, and no prospective donors have been inputted. Likewise, display page 1600 in FIG. 16 has a display panel 1602 illustrating campaign data relating to individual donors and their pledges and donations for a relationship action plan (RAP). Panel 1602 has a graphical representation showing donor information tabular form with pledge and activity information and can include user interface elements to enable a user to add and download documents and edit donor information relating to a respective donor; however, the tables are shown empty since no pledges or donations have yet been made. Dashboard page 1700 in FIG. 17 includes a display panel 1702 illustrating a graphical representation that shows summary information about one or more of total amount pledged, percentage of campaign goal met by donor pledges, and top donor information which is also empty or set to zero at the start of a campaign.

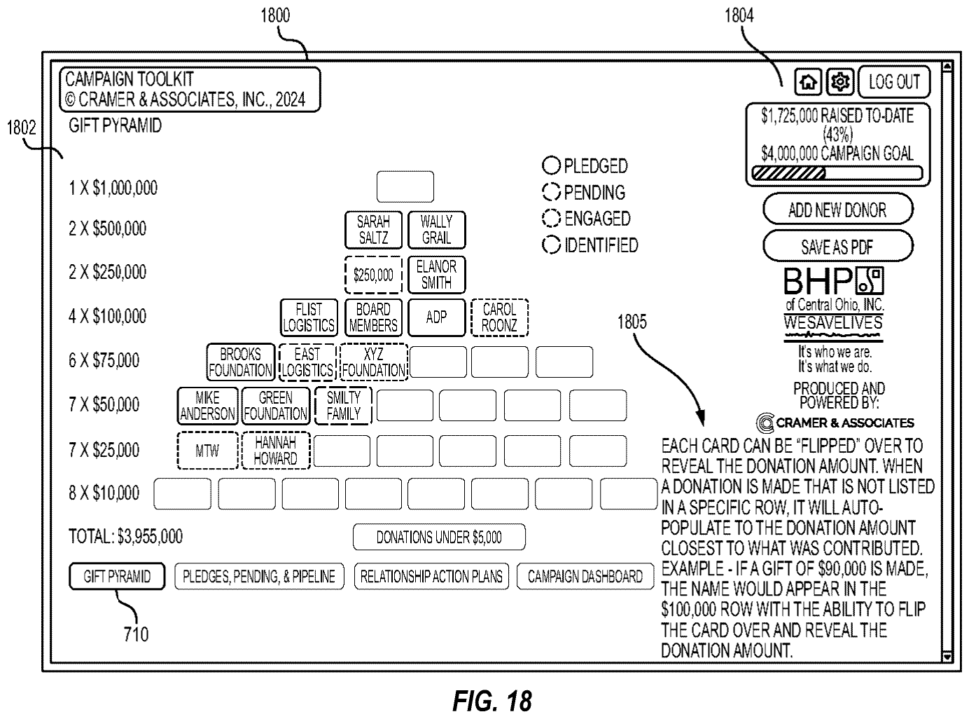

FIGS. 18-22 show campaign management pages 1800-2200 that may appear in the middle of a campaign. Display page 1800 in FIG. 18 has a display panel 1802 showing a graphical representation of a pyramid with multiple levels and boxes allocated for donor slots. Different boxes are styled according to their status (Pledged, Pending, Engaged or Identified). (The style may be with solid or dashed types of lines as shown to indicate a status or other graphical indication such as color or shape.) A box (such as box 1805) may be flipped to reveal a donation amount or other donor information. A box with a donor name or donor identifier indicated a donor has been associated with the allocated donor slot in the pyramid. Boxes shown in blank form indicate no pledges or other donor activity have yet been received in the campaign to date for that allocated donor slot.

A display panel area 1804 having user interface elements, such as, a button to enable a user to add new donor information and a button to enable the page with the graphical representation to be saved as a file in PDF or another file format as described above with respect to panel area 1404. A fundraising status indication such a bar graph and text showing amount raised to date and percentage of goal reached at this point in the middle of the campaign fundraising may be shown.

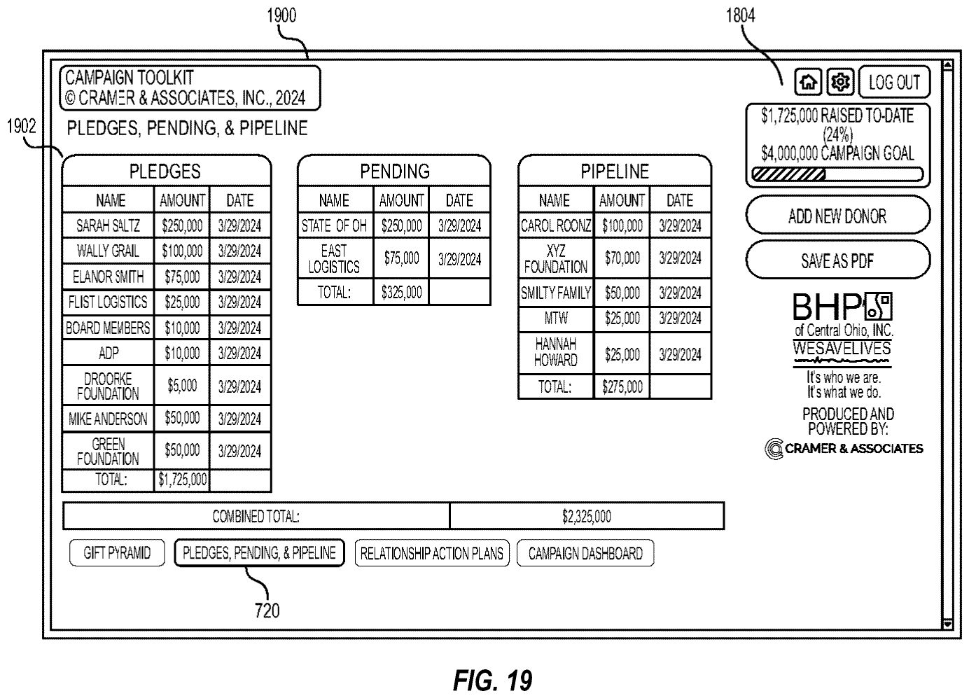

Display page 1900 in FIG. 19 has a display panel 1902 illustrating campaign data for pledges, pending pledges and donations received, and a pipeline of potential donors. Tables include rows of data for donor information to date for pledges or donations that have been made. A row of data may include for example name, amount and date of a pledge/donation by a donor.

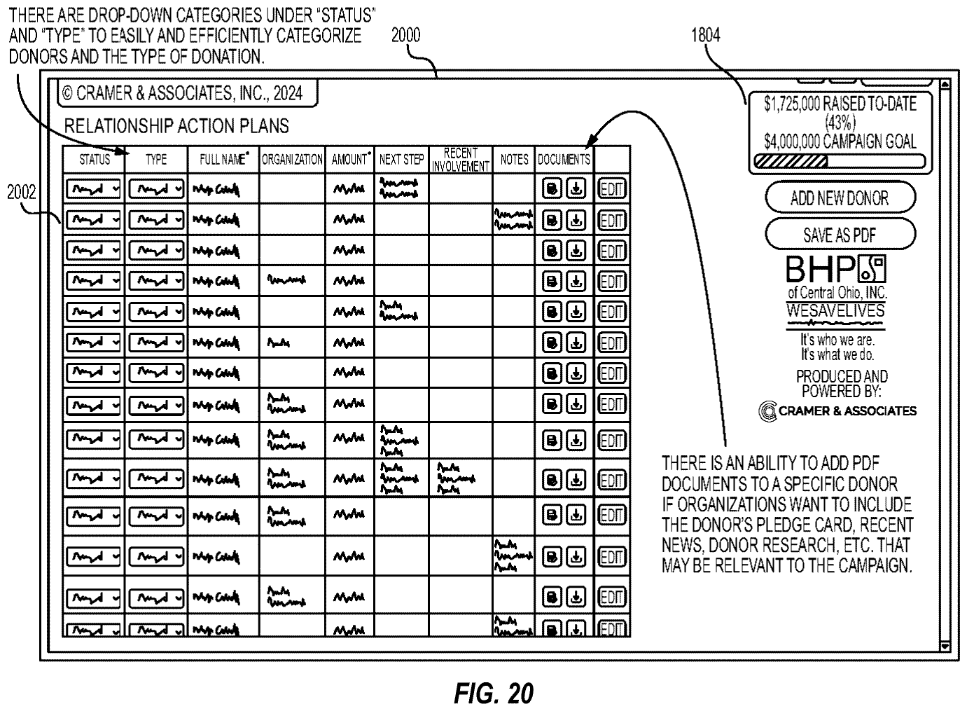

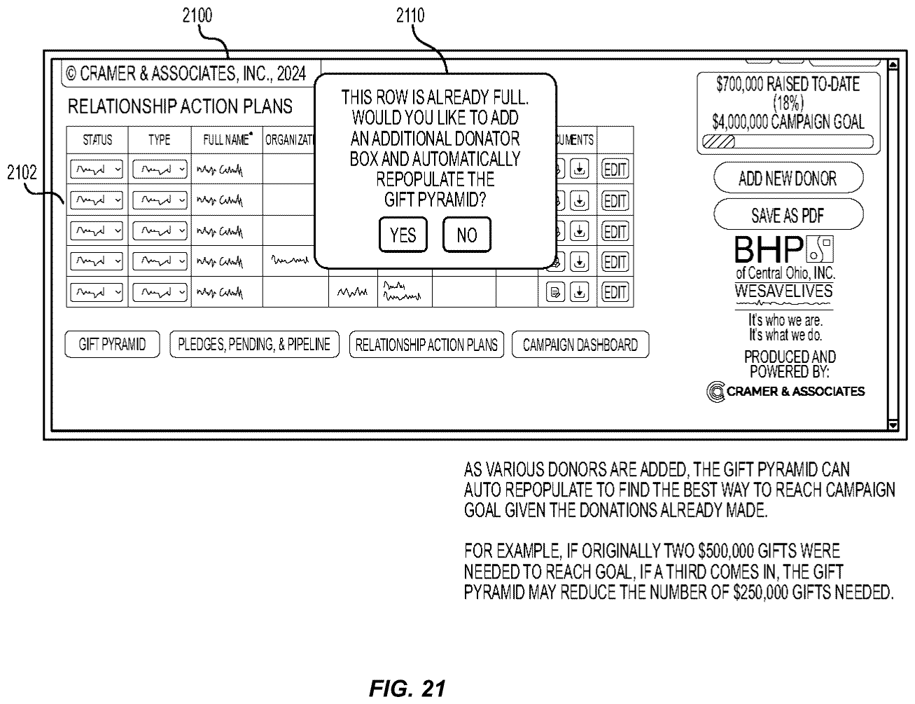

Likewise, display page 2000 in FIG. 20 has a display panel 2002 illustrating campaign data relating to individual donors and their pledges and donations for a relationship action plan (RAP). Panel area 2002 has a graphical representation showing donor information tabular form with pledge and activity information and can include user interface elements to enable a user to add and download documents and edit donor information relating to a respective donor. The tables are shown with rows with data for pledges or donations that have been made to date. FIG. 21 shows how a user may add new donor information to a RAP and then receive a query box 2110 in a page 2100 asking if the user wishes to automatically add the new donor information for display and reconfigure a new gift pyramid view to account for new added donor information.

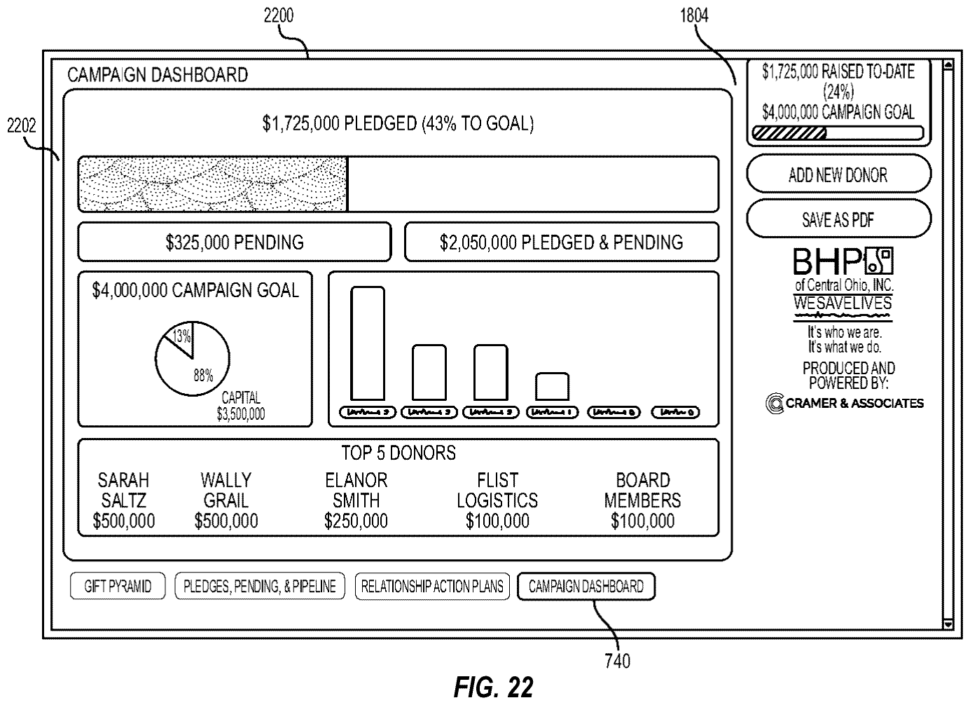

Dashboard page 2200 in FIG. 22 includes a display panel 2202 illustrating a graphical representation that shows summary information including total amount pledged/donated, percentage of campaign goal met by donor pledges/donations, and top donor information for the campaign data received to date in the middle of a campaign.

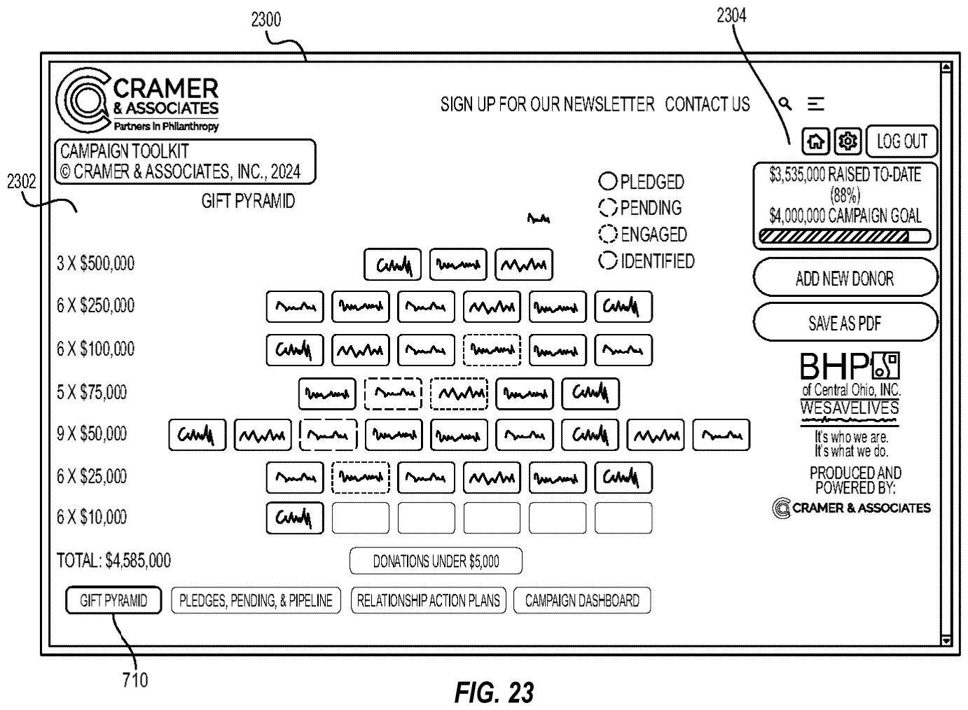

FIGS. 23-25 show campaign management pages 2300-2500 that may appear at the end of a campaign. Display page 2300 in FIG. 23 has a display panel 2302 showing a graphical representation of a pyramid with multiple levels and boxes allocated for donor slots. More boxes have donor name or identifier information because more pledges and donations have been received now the campaign is at an end. Different boxes are still styled according to their status. Blank boxes indicate allocated donor slots for which no donor was found.

A display panel 2304 having user interface elements, such as, a button to enable a user to add new donor information and a button to enable the page with the graphical representation to be saved as a file in PDF or another file format as described above with respect to panel area 1404. A fundraising status indication such a bar graph and text showing amount raised to date and percentage of goal reached at this point in the end of the campaign fundraising may be shown.

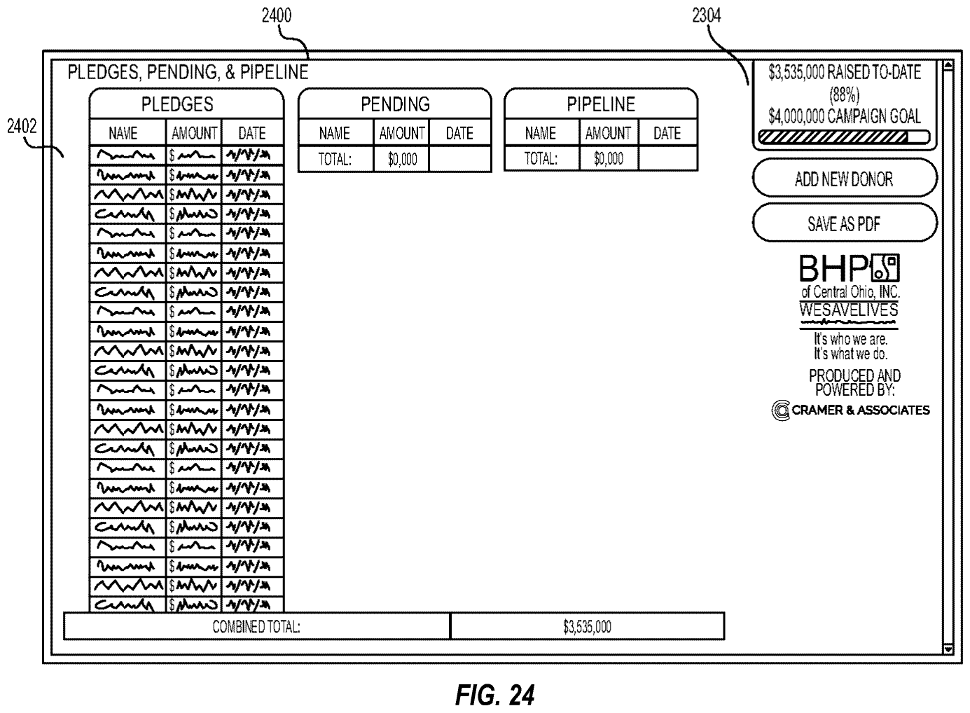

Display page 2400 in FIG. 24 has a display panel 2402 illustrating campaign data for pledges/donations. Since it is the end of a campaign, no pending or pipeline data remains. All final pledges to date are listed.

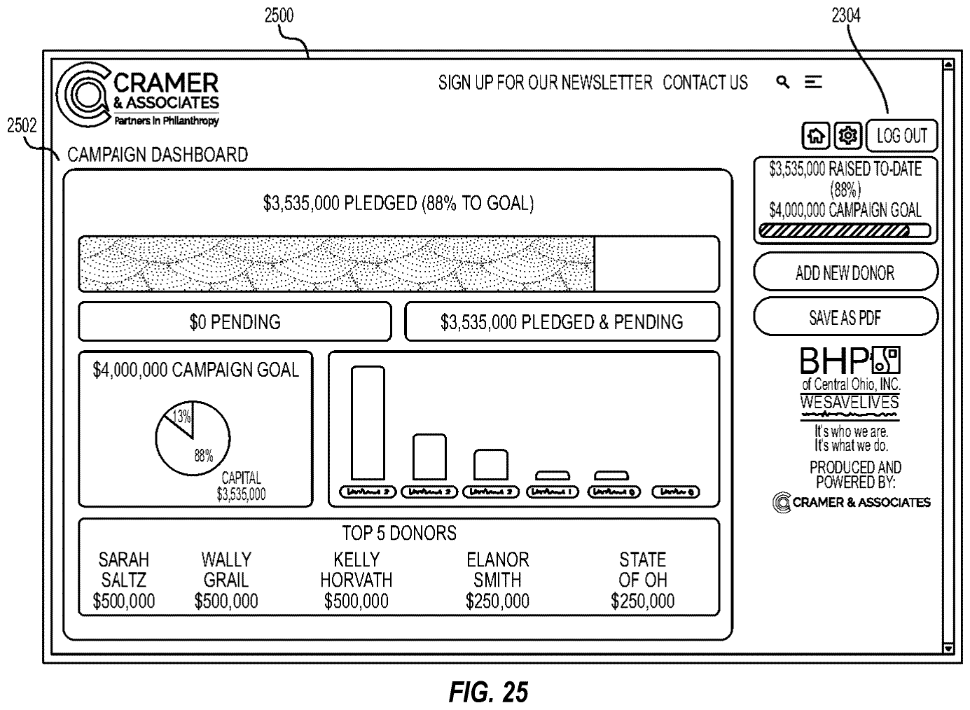

Dashboard page 2500 in FIG. 25 includes a display panel 2502 illustrating a graphical representation that shows summary information about one or more of total amount pledged/donated, percentage of campaign goal met by donor pledges/donations, and top donor information for the campaign data received to date in the end of a campaign. This display view can provide a helpful snapshot of the relative success of the campaign.

e. Pyramid Building

In a further feature, a new gift pyramid view may be automatically generated. FIG. 13 is a flowchart diagram of a computer-implemented method for generating a new gift pyramid display view 1300 in accordance with an embodiment (steps 1310-1370). In one embodiment, pyramid builder 128 may perform each of steps 1310-1370. For brevity, method 1300 will be described with respect to a pyramid built as shown in the example panel view 702 for a $2M campaign fundraising goal. Method 1300 is not limited to this example and other pyramid having different numbers of levels and allocation of donor slots may be used.

In step 1310, pyramid configuration data is stored. Pyramid builder 128 may store pyramid configuration data in database 130 or other accessible computer-readable memory. Pyramid configuration data may be part of campaign data 135 or a separate data structure. In one embodiment, pyramid configuration data may include an array of row configurations, a list of sorted donation thresholds, and a campaign data goal value. The values in the pyramid configuration data may be predetermined and set to default or administrator-selected values. Each row in the array corresponds to a level in the pyramid and has configuration data for one more initial donor slots. For example, in the fundraising gift pyramid of FIG. 7, the array may have eight row configurations. The campaign goal value is set to $2M USD. The list of donation amounts may include eight donation thresholds ($500K, $250K, $100K, $75K, $50K, $25K, $10K, and $5K.). The gift pyramid can have as many or as few donation levels as an organization needs.

In step 1320, pyramid builder 128 determines a donation amount for one donor slot in the top pyramid level. The donation amount may be set to the donation amount in the list equal to or closest to a percentage of the campaign goal. For example, the donation amount for the top donor slot in the fundraising gift pyramid is determined to be $500,000 which is 25% of the $2M campaign goal value and equal to the highest donation threshold amount ($500K) in the list. Pyramid builder 128 allocates one donor slot to the top pyramid level at the $500K donation amount determined in step 1320 and stores the determined donation amount value in the array.

Next in step 1330, pyramid builder 128 allocates donor slots for successive pyramid levels based on the donation amount for the respective pyramid level and a percentage of remaining campaign goal. Successively lower levels in the pyramid may correspond to successively lower donation threshold amounts in the list and may have the same number or increasingly larger numbers of allocated donor slots than higher pyramid levels.

In the fundraising gift pyramid, a percentage of remaining campaign goal may used such as 30%. The next donation amount in the list is $250K. For the second level (that is the next level below the top level), pyramid builder 128 then determines the number of donor slots for the level (that is the number of boxes). To determine this, pyramid builder 128 dividing a targeted amount for that level (calculated as a percentage of the remaining goal) by the donation amount, and ensures that the result does not exceed a row limit (8 boxes per row). (Because pyramid levels are represented by rows in the array, the terms levels and rows are used interchangeably here with respect to pyramid building).

Applying this to the fundraising gift pyramid example, $500K has already been allocated in the top level. $1.5M remains to be allocated of which 30% of the remaining campaign goal is targeted for the second level (that is $450K). To determine the number of boxes or donor slots, pyramid builder 128 divides the targeted amount for the second level ($450K) by the donation amount ($250K) for the second level, and ensures that the result does not exceed a row limit (8 boxes per row). In this case, the division yields one donor slot at the $250K donation amount for the second level which is less than 8 boxes.

Pyramid builder 128 likewise allocates donor slots for successive levels in the pyramid at the next corresponding donation amounts in the list. Applying this to the fundraising gift pyramid example, $750K has already been allocated in the top two levels. $1.25M remains to be allocated of which 30% of the remaining campaign goal is targeted for the third level (that is $375K). To determine the number of boxes or donor slots, pyramid builder 128 divides the targeted amount for the third level ($375K) by the donation amount ($100K) for the third level, and ensures that the result does not exceed a row limit (8 boxes per row). In this case, the division yields three donor slots at the $100K donation amount for the third level which is less than 8 boxes.

Successive levels up to a pyramid size are similarly allocated a number of donor slots based on the respective donation amount level and percentage of remaining campaign goal while making sure a row limit is not exceeded. Allocated donor slots and donation amounts are stored in the corresponding rows in the array.

In step 1340, pyramid builder 128 checks if the allocated donor slots in a pyramid meet the campaign goal. Meet the campaign goal may include reaching or exceeding the campaign goal amount or reaching a range near the campaign goal amount (such as within 5-10% of the campaign goal) or other predetermined threshold. If yes, the allocated donor slots in a pyramid meet the campaign goal (step 1342), control proceeds to end (step 1370). If no, the allocated donor slots in a pyramid do not meet the campaign goal (step 1344), control proceeds to step 1350.

In step 1350, adjustments may be made if the total amount for allocated donor slots is less than the campaign goal. Pyramid builder 128 traverses levels of the pyramid (that is the array of configuration data) and adds more donor slots up to a level limit and adds more rows up to a pyramid size limit. In the fundraising pyramid example of FIG. 7 a level limit may be 8 donor slots so that no more than 8 donor slots may be allocated for a pyramid level. A pyramid size limit may be 8 so that no more than 8 levels of a pyramid may be visible in a display. These examples are illustrative and a larger or smaller level limit and larger or smaller pyramid size limit may be used depending upon a particular application. This feature allows users to utilize manual and automatic pyramid calculations to develop a fundraising campaign strategy and ensure the campaign goal is reached based on their donor capacities.

In step 1360, pyramid builder 128 allocates remaining donor slots for threshold amounts not visible in a displayed pyramid view. For example, as shown in FIG. 7, a pyramid having eight levels may be built. The total amount of allocated donor slots adds up to $1,995,000 out of a $2M campaign goal. Other donations below $5,000 may be stored in the array but are not in the top eight rows visible in the pyramid. In this way, a user may more effectively view a majority of campaign data in the first eight levels as donations are received and donor slots fill. Again, the pyramid defaults to eight levels, however, users can add and remove rows and donation levels as needed, utilizing the manual feature to compliment the automatic population.

A remaining campaign goal percentage may be 30% as described above. Other percentages may also be used. In one example, the remaining campaign goal percentage used in step 1330 is initially 30% for the first four levels of a pyramid and then switched to 40% after four rows have been filled.

Next control proceeds to step 1370 (end). The stored array of configuration has rows of data corresponding to the allocated donor slots. A display view of a new gift pyramid may then be generated based on the array of configuration data built up and stored during method 1300.

As donors engage in activity (such as, by making pledges or remitting donation payments), status data in the array may be updated to reflect the activity. The pyramid may then be displayed with donor slots representative of the donor activity. For example, in one feature, a graphical indication may be presented for each donor slot that indicates status of donor activity (pledged, pending, engaged, or identified). The graphical indication may be a color, texture, shape or other indication. In this way, a user can easily see donor status for each of the allocated donor slots and assess the progress of the fundraising of a campaign towards meeting its goal. A user may also hover or flip or otherwise select a donor slot to reveal more information about a donor (such as, donor name, donor activity, or donation amount).

The description above for allocating and adjusting donor slots and setting level limits and pyramid size limits in different steps is illustrative and not intended to be limiting. As would be apparent to person skilled in the art given this description, allocating and adjusting donor slots and setting level limits and pyramid size limits may be performed on each level or group of levels as a pyramid in built and different sequences depending upon a particular application.

### 3. Example Hosted Server Implementation

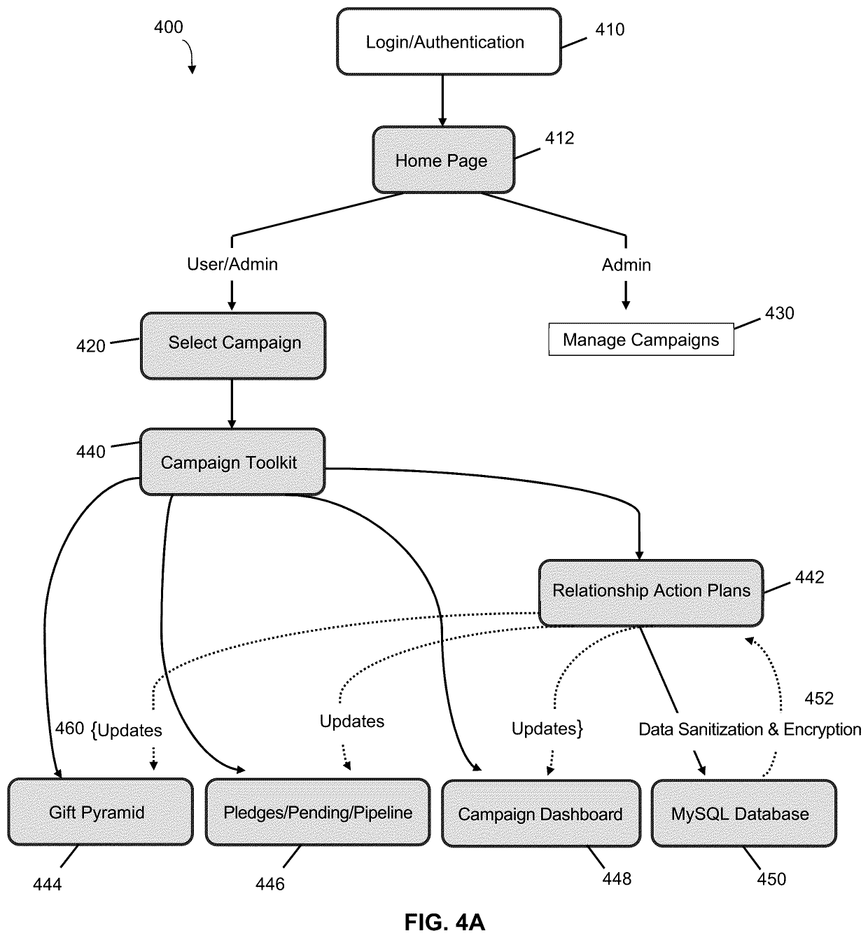

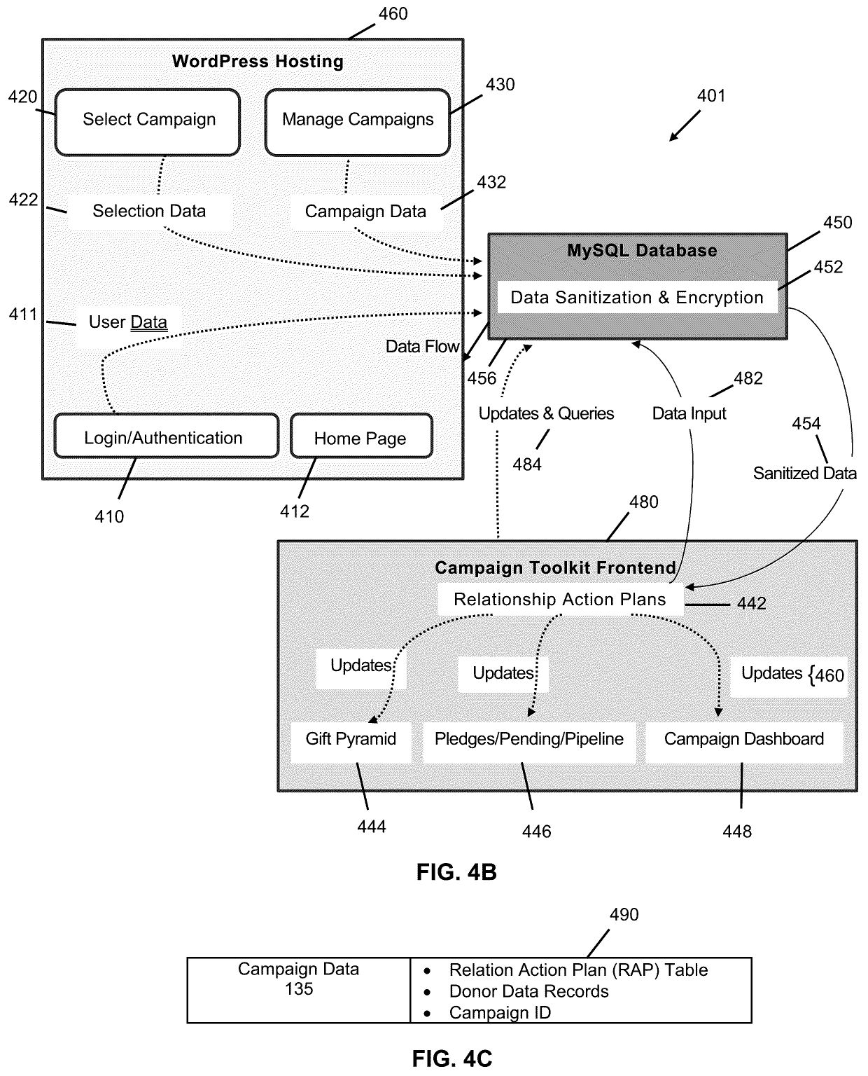

FIGS. 4A-4C further illustrate operation of a campaign toolkit system according to an embodiment. FIG. 4A shows an operational flow 400 that may be carried out by the campaign toolkit system 401 shown in FIG. 4B. Campaign toolkit system 401 can be implemented with a hosted server 460, a database 450 and campaign toolkit front end 480 running on a client device. In one example, hosted server 460 can be a web server hosted by a WORDPRESS web publishing platform and database 450 can be a MySQL database. FIG. 4C shows a table 490 having example campaign data 135 in accordance with an embodiment. The example campaign data 135 includes one or more relationship action plan (RAP) tables, donor data records, and a campaign ID for a campaign.

In operation, login and authentication of a user or administrator is performed (step 410). Server 460 receives and authenticates log-in credentials from a user or administrator (user data 411) accessing campaign toolkit frontend 480 on a client device.

After log-in and authentication, server 460 outputs a home page 412 to the user or administrator. Campaign toolkit frontend 480 receives home page and generates a display view of home page at the client device (step 412). A user or administrator may then select a campaign shown on the home page (step 420). Campaign toolkit frontend 480 sends a request corresponding to the selected campaign (selection data 422) to server 460. Server 460 then accesses database 450 and provides data for one or more pages relating to the selected campaign to campaign toolkit frontend 480 for display to the user or administrator. In this way, the user or administrator may navigate and make selections through pages served by server 460 for the selected campaign. In one feature, these pages may include pages shown in display views having data for a gift pyramid, pledges/pending/pipeline summary, campaign dashboard, or RAP table.

Administrators may be given more rights in campaign toolkit system 401 and allowed to manage campaigns (step 430). These rights may allow an administrator to create a new campaign, end a campaign or modify a campaign by providing campaign data and instructions (432). The rights may also allow an administrator to access or manage campaign including donor data for a campaign from database 450.

As shown in FIG. 4B, in one embodiment data sanitization and encryption of data stored and retrieved from database 450 may be performed (step 452). In this way, sanitized data 454 is output from database 450 through server 460 to a campaign toolkit frontend 480. Likewise, data input 482 from campaign toolkit frontend 480 may be sanitized for storage in database 450. Data relating to updates and queries 484 from campaign toolkit frontend 480 may also be sanitized for storage in database 450. As data is updated during a campaign, campaign toolkit frontend 480 also outputs updates 460 to pages showing a gift pyramid 444, PPP 446, or campaign dashboard 448. The updated data may be the result or updates made by server 460 to campaign data 135 including donor records and RAP tables (490) stored in database 450. In this way, campaign toolkit frontend 480 accessed updated data and a user or administrator can view updated data in the campaign management pages shown in a campaign toolkit.

### 4. Additional Processor-Implemented Embodiments and Example Implementations

Aspects of the embodiments for exemplary system 100, including server 107 with campaign toolkit manager 120 and its components 122, 124, 126, 128 and device 101 with campaign interface tool 112, may be implemented electronically using hardware, software modules, firmware, tangible computer readable or computer usable storage media having instructions stored thereon, or a combination thereof and may be implemented in one or more computer systems or other processing systems at the same location or different locations. Example computing devices that may be used by users include, but are not limited to, a mobile computing device (such as a smartphone or tablet computer), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device.

Embodiments may be directed to computer products comprising software stored on any computer usable medium such as memory. Such software, when executed in one or more data processing device, causes a data processing device(s) to operate as described herein.

In an embodiment, server 107 and database 130 may be implemented in an architecture distributed over one or more networks 105, such as, for example, a cloud computing architecture. Cloud computing includes but is not limited to distributed network architectures for providing, for example, software as a service (SaaS), infrastructure as a service (IaaS), platform as a service (PaaS), network as a service (NaaS), data as a service (DaaS), database as a service (DBaaS), backend as a service (BaaS), test environment as a service (TEaaS), application programming interface as a service (APIaaS), or an integration platform as a service (IPaaS).

Storage database 130 for example may be a database platform running database management software available from an organization such as a commercial vendor or open source community.

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other integrated circuit (IC) (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable, or machine-readable, instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A system for campaign data visualization, comprising:
a campaign tool kit manager implemented on a server configured to communicate over a data network with a remote computing device; and
a database coupled to the server and configured to store campaign data;
wherein the campaign toolkit manager includes:
a page generator configured to generate one or more pages visualizing campaign data;
a donor manager configured to manage donor information relating to a campaign; and
a pyramid builder configured to generate pyramid configuration data representative of allocated donor slots for a campaign.

2. The system of claim 1, wherein the remote computing device includes a campaign interface tool having a user-interface configured to enable a user to view pages output by the page generator on a display device and to make inputs to control visualization of campaign data displayed to the user.

3. The system of claim 2, wherein the page generator generates a home page having information identifying one or more campaigns and one or more user-interface elements enabling a user to select a respective campaign.

4. The system of claim 3, wherein the page generator generates a navigation page for a selected campaign, the navigation page having one or more campaign management buttons.

5. The system of claim 4, wherein the campaign comprises a fundraising campaign, and the one or more campaign management buttons include a set of four buttons comprising a gift pyramid button, a pledges, pending, pipeline (PPP) button, a relationship action plan (RAP) button, and a dashboard button.

6. The system of claim 5, wherein the page generator outputs a gift pyramid page for display in response to a user selection of the gift pyramid button using the campaign interface tool, and wherein the displayed gift pyramid page includes a graphical representation having an approximate pyramid shape made up of multiple levels each with one or more boxes corresponding to respective donor slots allocated for donors.

7. The system of claim 6, wherein the boxes in the graphical representation have a color or other indication denoting the status of a respective donor pledge.

8. The system of claim 6, wherein the user-interface at the campaign interface tool is configured to enable a user to select a box to flip or hover to view additional donor information.

9. The system of claim 2, wherein the stored campaign data includes a relationship action plan table, donor data records, and a campaign identifier (ID).

10. The system of claim 5, wherein the page generator outputs a PPP page for display in response to a user selection of the PPP button using the campaign interface tool, and wherein the displayed PPP page includes a graphical representation showing donor pledges to date, pending donor pledges, and a pipeline of the donor pledges.

11. The system of claim 5, wherein the page generator outputs a RAP page for display in response to a user selection of the RAP button using the campaign interface tool, and wherein the displayed RAP page includes a graphical representation showing donor pledge and activity information, and includes user interface elements to enable a user to add and download documents and edit donor information.

12. The system of claim 5, wherein the page generator outputs a campaign dashboard page for display in response to a user selection of the dashboard button using the campaign interface tool, and wherein the displayed campaign dashboard page includes a graphical representation showing summary information about one or more of total amount pledged, percentage of campaign goal met by donor pledges, and top donor information.

13. The system of claim 1, wherein the donor manager is further configured to update donor information for storage in the database in response to user inputs to pages displayed for a campaign, and wherein the page generator propagates the updated donor information in subsequent pages displayed for the campaign.

14. A computer-implemented method for managing campaign data visualization, comprising:
storing initial campaign data in a database;
generating, with a campaign toolkit implemented on a server, a home page having information identifying one or more campaigns and one or more user-interface elements enabling a user to select a respective campaign;
generating with the campaign toolkit a navigation page for a selected campaign, the navigation page having one or more campaign management buttons;
generating with the campaign toolkit one or more campaign management pages corresponding to selection by a user of one or more campaign management buttons;
enabling a user to view or update campaign data in respective campaign management pages;
storing updated campaign data in the database for access by the campaign toolkit; and
propagating the updated campaign data in one or more campaign management pages for a selected campaign.

15. The computer-implemented method of claim 14, wherein the campaign comprises a fundraising campaign, and the one or more campaign management buttons include one or more of a gift pyramid button, a pledges, pending, pipeline (PPP) button, a relationship action plan (RAP) button, or a dashboard button, and further comprising the step of enabling a user to view or edit with a campaign interface tool at a remote device a gift pyramid display page, a PPP page, a RAP page or a dashboard page in response a user selection of a respective gift pyramid button, a pledges, pending, pipeline (PPP) button, a relationship action plan (RAP) button, or a dashboard button.

16. The computer-implemented method of claim 14, wherein the campaign comprises a fundraising campaign, and the one or more campaign management buttons include a gift pyramid button, and further comprising the step of enabling a user to view or edit with a campaign interface tool at a remote device a gift pyramid display page in response a user selection of a respective gift pyramid button, wherein the gift pyramid display page includes a graphical representation having an approximate pyramid shape made up of multiple levels each with one or more boxes corresponding to respective donor slots allocated for donors.

17. A computer-implemented method for managing campaign data visualization for a fundraising campaign, comprising:
initializing campaign data with a campaign toolkit, implemented on a server and configured to communicate with a campaign interface tool on a remote device, including setting a campaign goal for the campaign;
generating pyramid configuration data representative of allocated donor slots for the campaign based on the initialize campaign data; and
generating a gift pyramid display page based on the pyramid configuration data for output to the campaign interface tool, whereby, a user can view or edit gift pyramid information shown in the gift pyramid display page.

18. The computer-implemented method of claim 17, wherein the pyramid configuration data includes an array of row configurations, a list of sorted donation thresholds, and the campaign goal, and wherein the generating the gift pyramid display page further includes:
determining a donation amount for a donor slot in a top level of a pyramid; and
allocating donor slots for successive pyramid levels based on the donation amount for respective levels within the pyramid and a percentage of remaining campaign goal to be allocated.

19. The computer-implemented method of claim 18, further comprising:
checking if allocated donor slots in pyramid meet campaign goal, and if not, traversing levels of pyramid and adding more donor slots up to a level limit and more levels up to a pyramid size limit, and allocating remaining donor slots for thresholds amounts not visible in a page having a pyramid display view.

20. The computer-implemented method of claim 17, wherein the initializing campaign data includes setting a time period for the campaign.
